(19) United States
(12) Patent Application Publication
(10) Pub. No.: US 2010/0261495 A1
(43) Pub. Date: Oct. 14, 2010

(54) Distributed hole recovery process using connectivity information

(76) Inventors: Xiaoyun Li, Dublin (IE); David Kennedy Hunter, Wivenhoe (GB)

Correspondence Address: XIAOYUN LI, 323 Nutgrove Avenue, Churchtown, Dublin, 14, IE

(21) Appl. No.: 12/385,560

(22) Filed: Apr. 13, 2009

(51) Int. Cl. H04B 7/00

(52) U.S. Cl. 455/513

(57) ABSTRACT

A distributed coverage hole recovery process using connectivity information is proposed for wireless sensor networks and other wireless networks. A link is said to exist between two nodes which are sufficiently close. After a un-triangulated hole is detected enclosing by links between N (N>3) active boundary nodes, the distributed hole recovery process activates one or two redundant nodes to recover the hole at each iteration. This process is performed iteratively by each of the active boundary nodes adjacent to the hole independently without any central controller. It requires 2 hops connectivity or neighbor information from each boundary node adjacent to the hole. After each hole recovery iteration, the hole is reduced in size or split into two smaller holes. Then the hole recovery process repeats until the hole is recovered or detected as unrecoverable.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The present invention relates to coverage hole detection in wireless sensor networks and other wireless networks.

2. Description of the Related Art

Wireless sensor networks (WSNs) have been widely researched as a technology for gathering sensed information such as temperature, pressure, humidity and vibration over a wide area and collecting it at one centralized point for storage and analysis. Such wireless sensor networks often cover a wide area, consisting of a very large number of nodes which may be densely deployed. Furthermore, the topology is often dynamic, both due to node failure, and due to physical movement of nodes. Low-cost deployment is one of the key objectives of wireless sensor networks, which together with the requirement for miniature sensor nodes with limited battery power implies that the resources available to individual nodes are severely limited. In particular, constraints on energy supply are unlikely to be relaxed in the foreseeable future, furthermore, sensor nodes are usually unattended and are often inaccessible to human operators. Therefore, it is very important in many WSN applications to provide energy-efficient surveillance and hence longer network lifetime.

However, tiny sensor nodes are prone to accidental failure; one can fail either because it is operating in a harsh environment, or simply because it has run out of energy. This may then produce “coverage holes” (or just “holes”), which are areas that are not covered by the sensing area of at least one node. In many highly secure sensor network applications such as habitat monitoring, infrastructure protection and forest fire monitoring systems, coverage holes must be detected and recovered immediately for security reasons. In such cases, if a coverage hole arises due to failure of one or more active nodes, only those nodes should be activated which are required to restore coverage in the affected area. Also, it is unlikely that very small resource-constrained nodes can determine their location accurately through technologies such as GPS, particularly in a large WSN.

An algebraic topological method based upon homology theory which can detect coverage holes in a WSN without coordinates has been proposed by De Silva, Ghrist, R. and Muhammad, A. It employs a centralized control algorithm that requires connectivity information about all nodes in the sensing area, but cannot guarantee to detect the boundary of a hole accurately. If there are N nodes, the complexity of the computation time for this algorithm is O(N⁵).

A boundary detection algorithm using a communication graph has also been proposed by Yue Wang et. al, Funke, S. and Klein, C. It selects one or more nodes as seeds, to build a shortest path tree by flooding. With no coverage holes in a continuous target area, nodes which lie the same number of hops away from the seed node should form an unbroken circle. Therefore each node can examine those neighbors which are an equal number of hops away from it, to determine whether such a circle can be formed. In this way, the boundary nodes of a coverage hole can be detected. This algorithm does not require node coordinates to be known, but the node density must be high enough to guarantee sufficient accuracy, which is not suitable for randomly deployed sensor networks, because the node density of the area adjacent to a hole is often lower than that of a hole-free area. Also, this algorithm cannot detect multiple adjacent holes. Another problem is the high communication overhead due to frequent flooding, which takes place when the network topology changes due to node failure or node mobility.

Zhang, H., and Arora, A. proposed GS3, and Wang, X. et al. proposed SoRCA. Both are self-healing algorithms to recover a hole by activating adjacent redundant nodes, but they require coordinate location information about all sensor nodes. These algorithms partition the target area into fixed hexagonal cells, and assume that a cell is covered if at least one node lies inside it, hence they generally cannot maintain full coverage (which is critical for WSN operation) without redundancy.

Xiaoyun Li and David Hunter proposed a coordinate-free hole detection algorithm called 3MeSH, to detect un-triangulated holes, and activate adjacent redundant nodes to recover the hole using a centralized hole recovery algorithm. The centralized hole recovery algorithm requires a central controller node with powerful computational ability and a large memory space in order to function in a high density sensor network.

Hence, there is a need for a fully distributed coverage hole recovery algorithm which does not require either the coordinates of sensor nodes, or a powerful central control node, and which should activate as small number of redundant nodes as possible to recover a hole, and detect accurate hole boundary if the hole is unrecoverable.

### BRIEF SUMMARY OF THE INVENTION

The main objective of the invention is to activate redundant nodes to triangulate (or recover) an un-triangulated hole, while guaranteeing that no unnecessary nodes are activated in order to save power.

The second objective of the invention is that the hole recovery process is distributed without any central controller, for the purpose of reliability and flexibility, and to avoid single point failure. It should also avoid making high requirements of computational and storage capacities for any node, and should not require any additional location equipment in resource constrained sensor networks.

The third objective of the invention is to detect the boundary of the hole accurately if the hole is unrecoverable.

After an un-triangulated hole is detected as being enclosed by polygon formed by links between N boundary nodes, the distributed hole recovery process activates one or two redundant nodes to recover the hole at each iteration. This process is performed iteratively by each of the active boundary nodes adjacent to the hole independently without any central controller. In order to recover the hole, each boundary node only needs to identify (via an appropriate signalling protocol) its neighbors, and its neighbors' neighbors. After each hole recovery process, the hole is either reduced in size or split into two smaller holes. Then the hole recovery process repeats until the hole is recovered or detected as unrecoverable after activating the necessary number of redundant nodes.

### BRIEF DESCRIPTION OF THE DRAWINGS

The present invention will become more understandable from the detailed description given herein below and the accompanying drawings which are given by way of illustration only, and thus are not limitative of the present invention. In the following figures, assume each node has sensing area defined by a circle with radius R, and a ‘link’ is said to exist between any two nodes which are closer than 2R units to each other.

FIG. 1. shows an example of a hole enclosed by a polygon with 6 edges, defined by 6 adjacent active boundary nodes {B₁ B₂ B₃ B₄ B₅ B₆}. One redundant node Al is activated by the hole recovery step 4, (as in the detailed description of the invention below), when it is connected by links to two boundary nodes B₁ and B₄ which are at least ┌N/3┐ hops apart. In this case, there are N=6 nodes in the ring, and nodes B₁ and B₄ are 3 hops apart.

FIG. 2 shows two redundant nodes A₁ and A₂ which are activated by the hole recovery step 4, when they are each connected to B₁ and B₄ which are at least ┌N/3┐ hops apart, and the hole is split into two smaller holes; much as in FIG. 1, there are N=6 nodes in the ring, and nodes B₁ and B₄ are 3 hops apart.

FIG. 3. shows an example which satisfies Necessary Condition 1, when a hole is triangulated by edges up to 6R units long.

FIG. 4. shows an example where a hole is triangulated by edges up to 2R units long, when the topology of the boundary nodes is the same as that in FIG. 3.

FIG. 5. is an illustration of the proof of Necessary Condition 3.

FIG. 6 shows an example where step 3 does not take place during the hole recovery process, and almost every redundant node adjacent to the hole is activated in an attempt to recover the hole until an unrecoverable hole is detected.

The bold polygons are unrecoverable holes. Each small circle centred by a dot is an activated redundant node, and each dot not at the center of a circle is an inactive node. This explanation is also applicable to FIGS. 7, 8 and 9.

FIG. 7 shows an example where step 3 does take place during the distributed hole recovery, and only a few redundant nodes adjacent to the hole are activated before an unrecoverable hole is detected. Hence the hole recovery process terminates earlier to avoid activating more redundant nodes.

FIG. 8 shows an example of hole detection and centrally controlled hole recovery by the 3MeSH algorithm. It shows that the centralized hole recovery process cannot detect the boundary of unrecoverable holes accurately after activating redundant nodes. Each dot on the bold polygons is a boundary node.

FIG. 9 shows an example of hole recovery using the distributed hole recovery process in the invention, while the topology is exactly the same as that of FIG. 8. It shows more accurate hole boundaries being detected after activating redundant nodes, compared to FIG. 8.

FIG. 10 shows a comparison of estimation of the computation time to recover a hole between the centralized 3MeSH hole recovery algorithm and the distributed hole recovery of the invention, when each node is equipped with a PIC 18f252 microprocessor.

FIG. 11 shows the mean communication time of the hole recovery process of the invention to recover a hole or detect an unrecoverable hole.

### DETAILED DESCRIPTION OF THE INVENTION

### A. Detailed Steps for the Invention

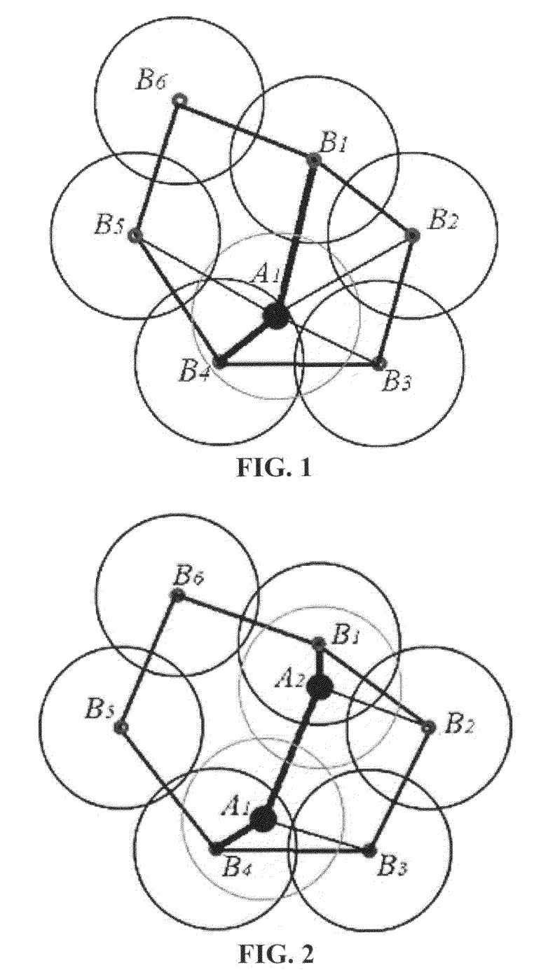

When a hole is detected as being enclosed by a polygon with N edges where N>3, (with each edge being a link between two adjacent active boundary nodes), each of the N boundary nodes has and only has links to two neighboring nodes among the other N−1 boundary nodes, and has no links to the other N−3 boundary nodes. FIG. 1. shows an example of a hole enclosed by a polygon with 6 edges defined by 6 adjacent active boundary nodes {B₁ B₂ B₃ B₄ B₅ B₆}.

Assume that each node has been allocated a node ID, and becomes aware of the IDs of its neighbors, by the end of the initial phase of setting up the network. When running the distributed hole recovery algorithm, each of the N boundary nodes adjacent to a detected hole only has to transmit a message to the others once or twice at most during each hole recovery iteration. Therefore each can be allocated a timeslot in advance at the following distributed hole recovery step 1 in order to avoid contention during the communication for the hole recovery process.

Inactive redundant nodes adjacent to the hole do not run the hole recovery algorithm, avoiding unpredictable message collisions from them, which is especially important with high node densities. However either one or two redundant nodes are activated after each iteration of the algorithm. If they cannot be activated immediately due to power saving, for example, because they are sleeping or switched off, then the process is delayed until they wake up.

It is assumed that through suitable signalling protocols, each node is aware of the IDs of its neighbors before hole recovery starts; these are called one-hop neighbors. Furthermore, each node has learned in a similar way the IDs of the neighbor nodes of each one-hop neighbor B. These neighbors of neighbors are called 2-hop neighbors below. The neighbor set of a node is the set of IDs of all nodes (both redundant nodes and active nodes) which are at a distance less than 2R units from it. Two boundary nodes are said to be n hops apart from one another if they are connected via a series of n−1 other mutually adjacent boundary nodes. There is no link between any two nodes more than 1-hop away from one another.

Distributed hole recovery steps:
Step 1: When a hole enclosed by N boundary nodes is detected, any one boundary node K broadcasts a hole message if no other node has done so. This message contains the IDs of all N boundary nodes, and, if it exists, the ID of one redundant node, connected directly to all these N boundary nodes, which can therefore recover the hole by itself, in which case hole recovery terminates early. Each boundary node is allocated a timeslot according to the sequence of IDs of all N boundary nodes.
Step 2: Each of the N boundary nodes broadcasts in its respective timeslot a neighbor message containing its own neighbor set. Then each boundary node discards unnecessary neighboring node(s) from its own neighbor set. To implement this, each boundary node must be aware not only of its own neighbors, but also its 2-hop neighbors. After that, each boundary node initializes the set P to contain the IDs of all the redundant nodes connected to it, before starting the redundant node filtering algorithm: if the neighbor set of a inactive node A (which is a member of P) is a subset of the neighbor set of any one of the N boundary nodes, then links from A offer no additional assistance in triangulating the hole, so A is removed from P, wherein an inactive node A's neighbor set includes all neighbor nodes connecting not only to A but also to at least one of the boundary nodes adjacent to the hole.
Step 3: Each boundary node tries to find a redundant node which is in the neighbor set of a neighboring boundary node. If no such redundant node exists, an unrecoverable hole is detected (see proof of Necessary Condition 2), and if no other node has already done so, the boundary node sends an unrecoverable hole message containing the IDs of all boundary nodes, and hole recovery terminates.
Step 4: Each boundary node tries to identify a redundant node in P which is connected to either a boundary node at least ┌N/3┐ hops away (FIG. 1) or another redundant node connecting to a boundary node at least ┌N/3┐ hops away (FIG. 2—see Necessary Condition 2). If one or two such redundant nodes are identified, they must be activated, and the boundary node broadcasts a hole recovery message containing their IDs if no other node has done so. ┌N/3┐ is the smallest integer no smaller than N/3.

Step 5: If no hole recovery message was sent during step 4, node K sends an unrecoverable hole message containing all the IDs of the boundary nodes, and hole recovery terminates. Otherwise, by activating the redundant nodes that have been identified, the hole is reduced in size to form one or two smaller holes. The hole recovery process then restarts from step 1 for each hole. However in step 2, only newly activated nodes need broadcast their neighbor messages.
*End of the distributed hole recovery process*

In step 4, it is difficult for two redundant nodes being activated by one boundary node to recover the hole, because each boundary node B is not aware which inactive node is filtered out by other boundary nodes, since some of the inactive nodes are more than 2 hops away from B. To solve this problem, the first option is that each boundary node broadcasts an updated neighbor message containing all IDs of its neighboring redundant nodes after running the redundant node filtering process, so that each boundary node B can find out whether any one of its neighboring redundant node is connected to a redundant node neighboring a boundary node at least ┌N/3┐ hops away from B after the redundant node filtering process. If it does, B broadcasts a hole recovery message containing the IDs of the two redundant nodes to be activated if no other boundary node has done so.

The second option is that to save energy and time, each boundary node does not broadcast an updated neighbor message as mentioned in the first option. Alternatively, if a boundary node B1 has found out that any one or more of its neighboring redundant nodes A are connected to an inactive node neighboring a boundary node B2 at least ┌N/3┐ hops away without knowing whether the inactive node neighboring B2 is filtered out or not, then B1 broadcasts the ID(s) of A during its timeslot. Each of the boundary nodes B2 allocated with a later timeslot and within at least ┌N/3┐ hops of B1 will check after the redundant node filtering process whether any of its neighboring redundant nodes is connected to B1's neighboring redundant node. If it does, B2 broadcasts a hole recovery message during its timeslot, containing the IDs of the two redundant nodes to be activated if no other boundary node has done so.

### B. Accurate Hole Boundary Detection

When a hole is reduced in size by activating one or two redundant nodes, the activated nodes may also connect via single edges to nodes other than the two boundary nodes which were at least ┌N/3┐ hops apart, and thus triangulate part of the hole. In this case, boundary nodes connected to the activated nodes may be discarded before the next iteration, except those (e.g. B₁ and B₅ in FIG. 1) connected to boundary nodes (e.g. B₆) which are not connected to the activated redundant node (e.g. A₁). Therefore only nodes in {B₁, B₆, B₅, A₁} are adjacent to the reduced hole of FIG. 1, yielding a more accurate hole boundary for the next iteration.

The elected redundant nodes become active nodes, and should not be considered as candidates for further node election. Otherwise, the same node may be repeatedly activated indefinitely.

### C. Proof of Necessary Conditions

An unrecoverable hole is always detected by step 4 of the algorithm, which is motivated by Necessary Condition 2. A check is made on each redundant node to determine whether it can meet this condition for hole recovery. If no such redundant node exists, the hole is regarded as unrecoverable. This is a necessary condition but it is not sufficient, so that redundant nodes which can recover the hole are never disregarded.

The distributed hole recovery process of the invention can recover a hole detected by any hole detection algorithm, even if there is no information available about whether a redundant node is within R units of a boundary node. In this case, in the absence of this information, all the adjacent redundant nodes within 2R units of one or more boundary nodes must be considered as candidates for recovering the hole. Because of this, the area covered by a boundary node B plus all the redundant nodes lying within 2R units of B lies within a circle with radius 3R centered on B. Hence this case, the hole is considered for recovery if it can be triangulated by edges connecting pairs of boundary nodes within 6R units of one another; otherwise it definitely cannot be recovered. This value of 6R is assumed in the remainder of the discussion below.

Based on the discussion above, it is now possible to state Necessary Condition I for recovery (triangulation) of a hole.
Necessary Condition 1. If a hole can be triangulated by edges between pairs of boundary nodes up to 6R apart, it may possibly be triangulated (i.e. recovered) by redundant nodes lying up to 2R units from any of the boundary nodes. Otherwise the hole cannot be recovered by one or more redundant nodes.
Necessary Condition 2. Assume a hole is enclosed by N boundary nodes and can be triangulated by long edges which are defined here as being up to 6R units long. For this to take place, it is necessary that such a long edge should exist which connects at least one pair of boundary nodes separated by ┌N/3┐ or more hops. This is a necessary condition for Necessary Condition 1.
Proof. If no such long edge connects any pair of boundary nodes separated by ┌N/3┐ or more hops, then long edges can only connect pairs of boundary nodes less than ┌N/3┐ hops apart. The only polygon that can be defined in this way by long edges must then have more than three edges, thus enclosing an area which cannot be triangulated. Therefore the hole cannot be recovered, proving the condition.

Necessary Condition 2 motivates the hole recovery process in step 4 of the 3MeSH-DR algorithm, which is described below and involves activating either:
one redundant node connected to two different boundary nodes at least ┌N/3┐ hops apart, or
two connected redundant nodes, which are each connected to two different boundary nodes at least ┌N/3┐ hops apart.

As shown above, if this is possible it may be possible to recover the hole. If Necessary Condition 2 is not met, hole recovery terminates early because the hole is unrecoverable, although some redundant nodes could perhaps be activated to cover part of it.

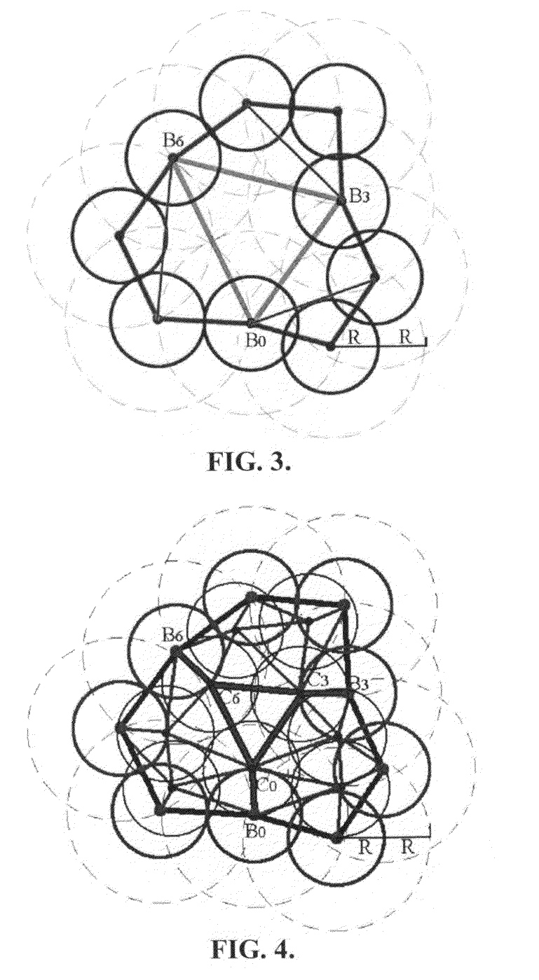

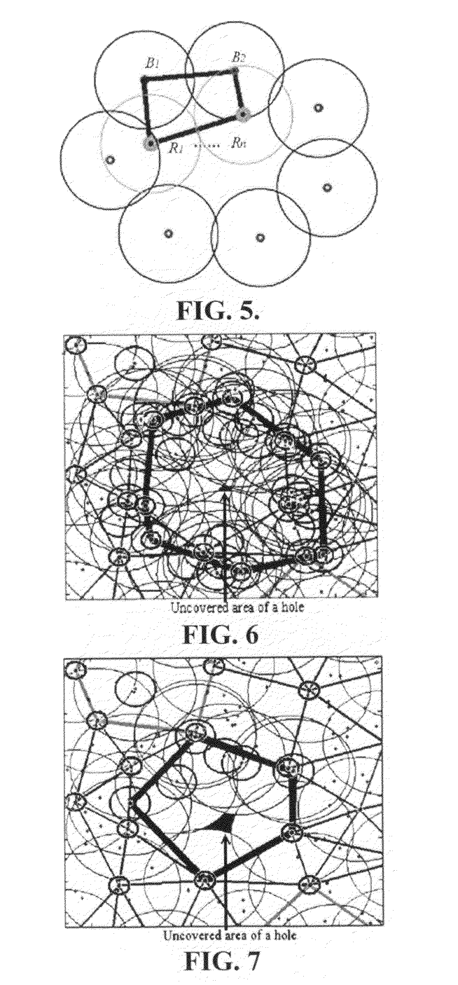

FIG. 3 shows a hole enclosed by a polygon with N (N=9) edges. Boundary nodes B₀, B₃ and B₆ are 3 (N/3=3) hops apart from one other, and they are connected by edges up to 6R units long (4R units in this example). According to Necessary Condition 1, it may be possible to triangulate the hole by activating redundant nodes each lying up to 2R units from one or more of the boundary nodes. This is in fact possible in this case, as shown in FIG. 4. C₀, C₃ and C₆ are the redundant nodes which are activated in order to recover the hole. They are fully connected by edges up to 2R units long, and each lie within R units of boundary nodes B₀, B₃ and B₆ respectively.
Necessary Condition 3. Any two neighboring boundary nodes must have at least one common redundant node connected to both of them. Otherwise the hole cannot be triangulated, so it cannot be recovered.
Proof. If two adjacent boundary nodes B₁ and B₂ have no common redundant nodes connected to them, then for any path between B₁ and B₂ {B₁ R₁ . . . Rₙ B₂} where n≧2 (FIG. 5), the polygon Pₘ={B₁ R₁ . . . Rₙ B₂ B₁} cannot be triangulated by edges between its vertices. This is because a triangle having a single edge for each side does not exist with B₁ and B₂ as vertices; therefore Pₘ cannot be partitioned into triangles. Hence the hole with B₁ and B₂ as boundary nodes cannot be recovered, proving Necessary Condition 3.

This is a necessary condition, but not a sufficient condition, because the common redundant node referred to above may not be inside the hole. However, it motivates an efficient way to check for an unrecoverable hole, because beforehand, most redundant nodes which are not necessary for hole recovery have been filtered out by step 3 of the invention, and will therefore not be considered by Necessary Condition 3.

### D. Computation Time for Hole Recovery

Sensor nodes that are deployed in real applications generally only have very simple and limited hardware for data processing and storage, because of various restrictions relating to hardware cost, physical size, and energy supply. For example, a sensor mote may be equipped with a PIC 18f252 microprocessor for data processing and storage, which has 1.5 KBytes of RAM for data storage and 32 KBytes of program memory. The running time for a 16-bit add operation is 2 μs.

With such simple hardware, a centralized hole recovery algorithm such as the 3MeSH algorithm would present serious problems. Firstly the calculation time for hole recovery would be unacceptably long, because such a microprocessor has limited computational power; this would be especially problematic for high node densities. Furthermore, again particularly with high node densities, the limited memory available would overflow if a central control node attempted to store all the relevant messages from adjacent nodes.

The following approximate calculations are intended to provide a rough indication of trends. To yield an approximate result, it is assumed for simplicity that there is a mean of Nλ nodes within the coverage area of the N boundary nodes adjacent to a hole, although the actual number of nodes surrounding a hole may be smaller because adjacent boundary nodes generally have overlapping sensing areas. The node density λ is the mean number of sensor nodes lying inside an area of πrR². For hole recovery to take place through activation of the relevant redundant nodes inside the hole using the original 3MeSH algorithm, the set of neighbors of each boundary node must be identified, and each pair of such sets must be compared. Each node A has a mean of 4λ neighbors, because any active node within distance 2R of A is its neighbor. Therefore the computation time for a PIC 18f252 microprocessor is (Nλ)²×(4λ)²×2 μs=32N²λ⁴ μs.

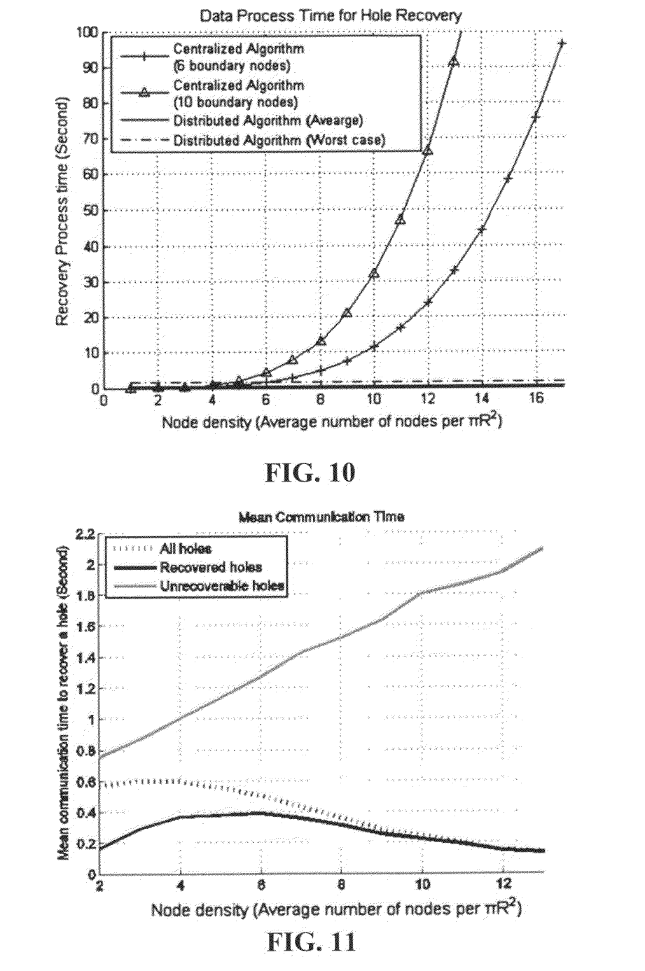

Using this approximate formula, FIG. 10 shows an estimation of the computation time for the centralized 3MeSH hole recovery algorithm, with varied node density λ, and for a mean of 6 boundary nodes. For λ=5, the recovery time is 0.7 seconds. This increases to 11.5 seconds for λ=10, which is unacceptable for time-critical applications. It would also very rapidly exhaust the energy of the central control node which is carrying out the calculations alone.

However for the distributed hole recovery process of the invention, considering a hole enclosed by N=10 boundary nodes, with high node density λ=10 (so that the mean number of nodes within a distance of 2R from a particular node is D=4λ), the calculation time is then D³×2 μs=128 ms for each boundary node.

### E. Experiment Results

Simulations were carried out with MATLAB 7.0 in Windows XP, in order to provide further insight into the operation of the invention. 1000 simulation runs were carried out in a target area of 64 units (1 unit=πR²) for each integer value of the node density (i.e. the mean number of nodes per unit area of πR²) between 2 and 13 inclusive, making a total of 12,000 simulation runs. Each simulation run employed a different randomly generated node configuration, with each node being randomly positioned, and independently from all other nodes.

During each simulation run, active nodes are elected randomly in the initial phase. If a node is not covered by any active node within distance R, it can elect itself as an active node. A node becomes redundant if it is covered by one or more active nodes. The active node election phase terminates once each node becomes either active or redundant, however coverage holes may exist where part of the target area is not covered by one or more active nodes. Unrecoverable holes may also arise in a sparse area if a coverage hole cannot be recovered by activating adjacent redundant nodes.

During the 12,000 simulations, 126,435 holes were detected using the 3MeSH hole detection algorithm. Then the hole recovery process of the invention tried to recover these holes. 105,124 holes were recovered. Moreover, 83,237 of the 105,124 holes were recovered by activating only one redundant node in the first step of the algorithm. Furthermore, 21,311 holes were identified as being unrecoverable,

FIG. 6 shows an example where nearly all redundant nodes inside the hole are activated when trying to recover the hole with the distributed hole recovery step 2 omitted, and finally the algorithm fails to recover the hole after 30 iterations. However in FIG. 7, with the distributed hole recovery step 2 reinstated, the algorithm terminates early once a boundary node realizes that the hole is unrecoverable, to achieve better efficiency and avoid activating more redundant nodes unnecessarily. The simulation results show that over 95% of holes can be recovered, or identified as unrecoverable, in three or fewer iterations of the distributed hole recovery process.

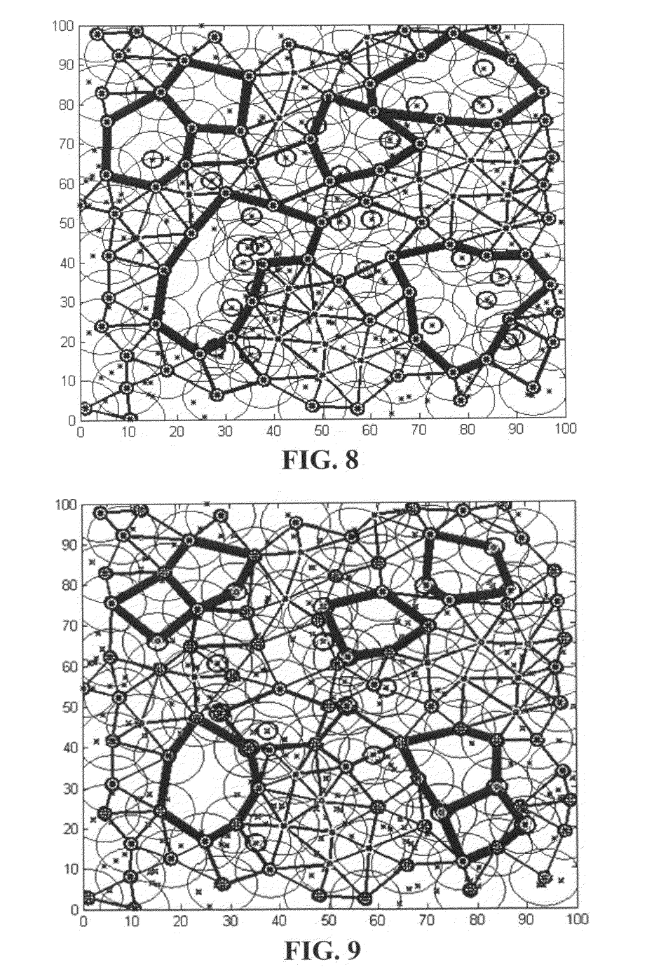

The invention can detect the boundary of an unrecoverable hole accurately, because in step 2, all unnecessary redundant nodes that do not contribute to triangulation are filtered out. Hence during each iteration, the hole is divided into two smaller holes or reduced in size, in order to identify a more accurate boundary, and this repeats until the hole is identified as being unrecoverable. For example, see the comparison of FIG. 8 and FIG. 9 between 3MeSH (with centralized hole recovery) and the invention (with distributed hole recovery) with the same node deployment. The small black circles are redundant nodes which are activated, and the bold polygons are detected unrecoverable holes. The centralized 3MeSH algorithm (FIG. 8) only detects the hole enclosed by the active boundary nodes, whereas the invention (FIG. 9) not only detects the hole enclosed by the active boundary nodes, but also activates redundant nodes so that unrecoverable holes are either partly recovered or divided into smaller holes. Therefore, this example shows how the invention detects the boundaries of unrecoverable holes more accurately.

FIG. 11 shows that the mean communication time for hole recovery is almost constant, and is not sensitive to node density, which is no more than 0.6 seconds for all node densities as verified by the 12000 simulations. For unrecoverable holes, the mean communication time for hole recovery increases for higher node density, but the longest mean communication time is less than 2.2 seconds for a node density of 13. But for high node densities with λ>11, the percentage of unrecoverable holes is less than 0.25% according to the simulation results, therefore the mean communication time for all holes' recovery decreases for higher node densities.

1. A method of distributed hole recovery process using connectivity information: after a hole is detected to be enclosed by a polygon with N edges where N>3, with each edge being a link between two adjacent active boundary nodes. Any of the N boundary nodes adjacent to the hole tries to activate one or two redundant nodes to recover or reduce the hole according to the boundary node's 2-hop connectivity information. This process repeats until the hole is recovered or an unrecoverable hole is detected, wherein said a hole is an un-triangulated coverage hole in wireless sensor networks or other wireless networks, wherein said a link exists between any two nodes within a certain distance or any signal strength being detected by both nodes within certain threshold value, wherein a neighbor or one hop neighbor to node A is a node connected to node A with a link.

2. A method of distributed hole recovery process of claim 1 wherein distributed hole recovery process means the process is implemented by each active boundary node adjacent to the hole without a central controller, although a single central controller node can implement the same method assuming longer computational time and more memory. Alternatively, if each inactive node adjacent to the hole is awaken, it can also determine whether or not to activate itself to recover the hole, although this may cause collision if more than one redundant node activate themselves at the same time, wherein an inactive node adjacent to a hole is an inactive node connecting to any boundary node adjacent to the hole within certain distance.

3. A redundant node of claim 1 is an inactive node whose neighbor set is not a subset of the neighbor set of any boundary node adjacent to the hole, wherein an inactive node A's neighbor set includes all nodes connecting not only to A but also to at least one of the boundary nodes. If an inactive node's neighboring set is a subset of the neighboring set of any boundary node B, this inactive node is filtered out by a redundancy filter process, since all its links has no more contribution to recover the hole than the boundary node B. The redundancy filter process can be implemented by each of the N boundary nodes, or by each of the inactive node adjacent to the hole, depending on how many nodes are involved in the hole recovery process as described in claim 2.

4. The one redundant node which recovers or reduces the hole of claim 1, should connect to at least two boundary nodes no less than ┌N/3┐ hops away, wherein ┌N/3┐ is the smallest integer not smaller than N/3. If two redundant nodes are to be activated, they should be connected, and each of them is connected to at least 2 boundary nodes B1 and B2 respectively, wherein B1 and B2 are no less than ┌N/3┐ hops apart.

5. A recovered hole of claim 1 is a hole enclosed by a polygon with N edges, which can be triangulated in a planar graph by links between activated redundant nodes and the N boundary nodes.

6. An unrecoverable hole of claim 1 can be detected if no redundant node in claim 4 can be activated to recover the hole. Also if each of the N boundary nodes checks whether there is at least 1 redundant node connecting to it and its 1-hop neighboring boundary node, if no such redundant node is found, an unrecoverable hole is detected. This process to find out a common neighbor for neighboring boundary nodes is an option to detect an unrecoverable hole with quicker convergence.

7. A method of distributed hole recovery process of claim 1 can be applied not only in wireless sensor networks or wireless networks, but also in any computational geometry field to recover a hole using connectivity information.
